(19) United States
(12) Patent Application Publication
(10) Pub. No.: US 2006/0115669 A1
(43) Pub. Date: Jun. 1, 2006

(54) Curable composition, cured product, and laminate

(76) Inventors: Noriyasu Shinohara, Tokyo (JP); Yasunobu Suzuki, Tokyo (JP); Takayoshi Tanabe, Tsukuba Ibaraki (JP)

Correspondence Address: NIXON & VANDERHYE, PC, 901 NORTH GLEBE ROAD, 11TH FLOOR, ARLINGTON, VA, 22203, US

(21) Appl. No.: 10/546,206

(22) PCT Filed: Feb. 18, 2004
(86) PCT No.: PCT/NL04/00125

§ 371 Date: Oct. 5, 2005

(30) Foreign Application Priority Data
Mar. 7, 2003 (JP) 2003-060897

(51) Int. Cl. B32B 27/42

(52) U.S. Cl. 428/524; 528/310

(57) ABSTRACT

To provide a curable composition having excellent applicability and capable of forming a coat (film) having high hardness and high refractive index, excelling in scratch resistance and adhesion to a substrate and a low-refractive-index layer, and excelling in scratch resistance even in the case where the cured product is allowed to stand in a high pH environment or the composition is cured under anaerobic conditions on the surface of various types of substrates, a cured product of the curable composition, and a laminate having low reflectance and excelling in chemical resistance. Means for the Solution. A curable composition comprising (A) particles obtained by bonding oxide particles of at least one element selected from the group consisting of silicon, aluminum, zirconium, titanium, zinc, germanium, indium, tin, antimony, and cerium with an organic compound having a polymerizable unsaturated group, (B) a melamine compound having no polymerizable unsaturated group, and (C) a compound which has a polymerizable unsaturated group and has a hydroxyl value of 110 mgKOH/g or more.

### DESCRIPTION OF THE INVENTION

1. Field of the Invention

The present invention relates to a curable composition, a cured product of the curable composition, and a laminate. More particularly, the present invention relates to a curable composition having excellent applicability and capable of forming a coat (film) having high hardness and high refractive index and excelling in scratch resistance and adhesion to a substrate and a low-refractive-index layer on the surface of various types of substrates such as plastic (polycarbonate, polymethylmethacrylate, polystyrene, polyester, polyolefin, epoxy resin, melamine resin, triacetyl cellulose resin, ABS resin, AS resin, norbornene resin, etc.), metals, wood, paper, glass, and slates, to a cured product of the curable composition, and to a laminate having a low reflectance and excelling in chemical resistance. The curable composition, the cured product, and the laminate of the present invention are suitable as a protective coat material for preventing occurrence of scratches or stains on plastic optical parts, touch panels, film-type liquid crystal elements, plastic containers, and flooring materials, wall materials, and artificial marbles used as architectural interior finish; an antireflection film for film-type liquid crystal elements, touch panels, or plastic optical parts; an adhesive or a sealing material for various types of substrates; a vehicle for printing ink; and the like. The curable composition, the cured product, and the laminate can be particularly suitably used as an antireflection film.

2. Prior Art

In recent years, as a protective coat material for preventing scratches or stains on the surface of various types of substrates, an adhesive and a sealing material for various types of substrates, and a vehicle for printing ink, a curable composition having excellent applicability and capable of forming a cured film excelling in hardness, scratch resistance, abrasion resistance, low curling properties, adhesion, transparency, chemical resistance, and appearance on the surface of the substrate has been demanded.

In applications of an antireflection film for film-type liquid crystal elements, touch panels, or plastic optical parts, a curable composition capable of forming a cured film having a high refractive index in addition to the above properties has been demanded.

Various types of compositions have been proposed to satisfy such a demand. However, a curable composition having excellent applicability and capable of producing a cured film having high hardness and high refractive index, excelling in scratch resistance and adhesion to a substrate and a low-refractive-index film used in a laminate, and having a low reflectance and excellent chemical resistance when used for a laminate in which a low-refractive-index film is laminated on the cured film by coating has not yet been developed.

For example, a technology of using a composition containing particles obtained by modifying the surface of colloidal silica with methacryloxysilane and an acrylate as a radiation (photo) curable coat material is proposed (patent document 1). In recent years, this type of radiation curable composition has been widely used due to excellent applicability and the like (patent documents 2 to 7).

However, in the case where a low-refractive-index film is applied and layered on a cured product of such a composition and the laminate is used as an antireflection film, although the antireflection effect is improved to some extent, scratch resistance and chemical resistance of the laminate are not necessarily sufficient. Specifically, scratch resistance of the laminate easily deteriorates in the case where the laminate is allowed to stand in a high pH environment.

The step of curing the composition by applying radiation (light) is performed in ambient atmosphere in many cases. However, it is preferable to allow the curing reaction to occur under anaerobic conditions since oxygen in air may inhibit the polymerization reaction. However, scratch resistance is decreased in the case where a conventional composition is cured under anaerobic conditions such as in nitrogen atmosphere.

Patent Document 1

Japanese Patent Publication No. 62-21815

Patent Document 2

Japanese Patent Application Laid-open No. 10-273595

Patent Document 3

Japanese Patent Application Laid-open No. 2000-143924

Patent Document 4

Japanese Patent Application Laid-open No. 2000-281863

Patent Document 5

Japanese Patent Application Laid-open No. 2000-49077

Patent Document 6

Japanese Patent Application Laid-open No. 2001-89535

Patent Document 7

Japanese Patent Application Laid-open No. 2001-200023

### PROBLEMS TO BE SOLVED BY THE INVENTION

The present invention has been achieved in view of the above problems. An object of the present invention is to provide a curable composition having excellent applicability and capable of forming a coat (film) having high hardness and high refractive index, excelling in scratch resistance and adhesion to a substrate and a low-refractive-index layer, and excelling in scratch resistance even in the case where the cured product is allowed to stand in a high pH environment or the composition is cured under anaerobic conditions on the surface of various types of substrates, a cured product of the curable composition, and a laminate having low reflectance and excelling in chemical resistance.

### MEANS FOR SOLVING THE PROBLEMS

The present inventors have conducted extensive studies to achieve the above object. As a result, the present inventors have found that all the above properties can be satisfied by a curable composition comprising (A) particles obtained by bonding oxide particles of a specific element with an organic compound having a polymerizable unsaturated group, (B) a melamine compound having no polymerizable unsaturated group, and (C) a compound which has a polymerizable unsaturated group and has a hydroxyl value of 110 mgKOH/g or more, a cured product of the curable composition, and a laminate. This finding has led to the completion of the present invention.

Specifically, the present invention provides the following curable composition, cured product of the curable composition, and laminate suitable as an antireflection film.

1. A curable composition comprising (A) particles obtained by bonding oxide particles of at least one element selected from the group consisting of silicon, aluminum, zirconium, titanium, zinc, germanium, indium, tin, antimony, and cerium with an organic compound having a polymerizable unsaturated group, (B) a melamine compound having no polymerizable unsaturated group, and (C) a compound which has a polymerizable unsaturated group and has a hydroxyl value of 110 mgKOH/g or more.

2. The curable composition according to [1], wherein the organic compound in the particles of the component (A) comprises a group shown by the following formula (1) in addition to the polymerizable unsaturated group. 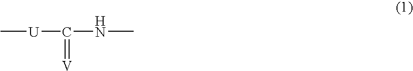
wherein U represents NH, O (oxygen atom), or S (sulfur atom), and V represents O or S.

3. The curable composition according to [1] or [2], wherein the compound (C) is a hydroxyl group-containing (meth)acrylate.

4. The curable composition according to [3], wherein the compound (C) includes pentaerythritol triacylate or isocyanuric acid diacrylate.

5. The curable composition according to any one of the above 1 to 4, further comprising (D) an acid generator in addition to the components (A), (B), and (C).

6. A cured product obtained by curing the curable composition according to any one of the above [1] to [5].

7. A process for producing a cured film comprising a step of curing the curable composition according to any of [1] to [5] under anaerobic conditions.

8. A laminate comprising a cured film obtained by curing the curable composition according to any of [1] to [5] and a low-refractive-index film which are layered on a substrate in that order.

### EMBODIMENT OF THE INVENTION

An embodiment of the curable composition, the cured product of the curable composition, and the laminate of the present invention is described below in detail.

I. Curable Composition

The curable composition of the present invention comprises (A) particles obtained by bonding oxide particles of a specific element (hereinafter may be referred to as “oxide particles (Aa)”) with an organic compound having a polymerizable unsaturated group (hereinafter may be referred to as “organic compound (Ab)”) (hereinafter may be referred to as “reactive particles (A)” or “component (A)”), (B) a melamine compound having no polymerizable unsaturated group (hereinafter may be referred to as “compound (B)” or “component (B)”), and (C) a compound having a polymerizable unsaturated group and having a hydroxyl value of 110 mgKOH/g or more (hereinafter may be referred to as “compound (C)” or “component (C)”).

The components of the curable composition of the present invention are described below in detail.

1. Reactive Particles (A)

The reactive particles (A) used in the present invention are obtained by bonding the oxide particles (Aa) of at least one element selected from the group consisting of silicon, aluminum, zirconium, titanium, zinc, germanium, indium, tin, antimony, and cerium with the organic compound (Ab) having a polymerizable unsaturated group (preferably, a specific organic compound having the group shown by the formula (1)).

(1) Oxide Particles (Aa)

The oxide particles (Aa) used in the present invention are oxide particles of at least one element selected from the group consisting of silicon, aluminum, zirconium, titanium, zinc, germanium, indium, tin, antimony, and cerium from the viewpoint of colorlessness of a cured film of the resulting curable composition.

As examples of the oxide particles (Aa), particles of silica, alumina, zirconia, titanium oxide, zinc oxide, germanium oxide, indium oxide, tin oxide, indium-tin oxide (ITO), antimony oxide, cerium oxide, and the like can be given. Of these, particles of silica, alumina, zirconia, and antimony oxide are preferable from the viewpoint of high hardness. These particles may be used either individually or in combination of two or more. The oxide particles (Aa) are preferably either powder or solvent dispersion sol. If the oxide particles are solvent dispersion sol, the dispersion medium is preferably an organic solvent from the viewpoint of miscibility and dispersibility with other components. As examples of organic solvents, alcohols such as methanol, ethanol, isopropanol, butanol, and octanol; ketones such as acetone, methyl ethyl ketone, methyl isobutyl ketone, and cyclohexanone; esters such as ethyl acetate, butyl acetate, ethyl lactate, □-butyrolactone, propylene glycol monomethyl ether acetate, and propylene glycol monoethyl ether acetate; ethers such as ethylene glycol monomethyl ether and diethylene glycol monobutyl ether; aromatic hydrocarbons such as benzene, toluene, and xylene; amides such as dimethylformamide, dimethylacetamide, and N-methylpyrrolidone; and the like can be given. Of these, methanol, isopropanol, butanol, methyl ethyl ketone, methyl isobutyl ketone, ethyl acetate, butyl acetate, toluene, and xylene are preferable.

The number average particle diameter of the oxide particles (Aa) is preferably 0.001-2 μm, still more preferably 0.001-0.2 μm, and particularly preferably 0.001-0.1 μm. If the number average particle diameter exceeds 2 μm, transparency of the resulting cured product may be decreased or surface conditions of the resulting film may be impaired. Various types of surfactants and amines may be added in order to improve dispersibility of the particles.

As examples of commercially available products of silicon oxide particles (silica particles, for example), colloidal silica such as Methanol Silica Sol, IPA-ST, MEK-ST, NBA-ST, XBA-ST, DMAC-ST, ST-UP, ST-OUP, ST-20, ST-40, ST-C, ST-N, ST-O, ST-50, ST-OL (manufactured by Nissan Chemical Industries, Ltd.), and the like can be given. As examples of commercially available products of powdered silica, AEROSIL 130, AEROSIL 300, AEROSIL 380, AEROSIL TT600, and AEROSIL OX50 (manufactured by Nippon Aerosil Co., Ltd.), Sildex H31, H32, H51, H52, H121, H122 (manufactured by Asahi Glass Co., Ltd.), E220A, E220 (manufactured by Nippon Silica Industrial Co., Ltd.), SYLYSIA 470 (manufactured by Fuji Silysia Chemical, Ltd.), SG Flake (manufactured by Nippon Sheet Glass Co., Ltd.), and the like can be given.

As aqueous dispersion products of alumina, Alumina Sol-100, -200, -520 (manufactured by Nissan Chemical Industries, Ltd.) can be given. As isopropanol dispersion products of alumina, AS-1501 (manufactured by Sumitomo Osaka Cement Co., Ltd.) can be given. As toluene dispersion products of alumina, AS-150T (manufactured by Sumitomo Osaka Cement Co., Ltd.) can be given. As toluene dispersion products of zirconia, HXU-110JC (manufactured by Sumitomo Osaka Cement Co., Ltd.) can be given. As aqueous dispersion products of zinc antimonate powder, Celnax (manufactured by Nissan Chemical Industries, Ltd.) can be given. As powder or solvent dispersion products of alumina, titanaium oxide, tin oxide, indium oxide, zinc oxide, etc., NanoTek (manufactured by C.I. Kasei Co., Ltd.) can be given. As aqueous dispersion sol of antimony doped-tin oxide, SN-100D (manufactured by Ishihara Sangyo Kaisha, Ltd.) can be given. As ITO powder, a product manufactured by Mitsubishi Materials Corporation can be given. As aqueous dispersion product of cerium oxide, Needral (manufactured by Taki Chemical Co., Ltd.) can be given.

The shape of the oxide particles (Aa) may be globular, hollow, porous, rod-like, plate-like, fibrous, or amorphous. The oxide particles (Aa) are preferably in the globular shape. The specific surface area of the oxide particles (Aa) (determined by a BET method using nitrogen) is preferably 10-1000 m²/g, and still more preferably 100-500 m²/g. The oxide particles (Aa) may be used either in the form of dry powder or dispersion in water or an organic solvent. For example, dispersion liquid of fine oxide particles known in the art as solvent dispersion sol of the above oxides may be used. In particular, use of solvent dispersion sol of oxide is preferable in applications in which high transparency is necessary for the cured product.

(2) Organic Compound (Ab)

The organic compound (Ab) used in the present invention is a compound having a polymerizable unsaturated group in the molecule. The organic compound (Ab) is preferably a specific organic compound having the group [—U—C(═V)—NH—] shown by the above formula (1). The organic compound (Ab) preferably has a group [—O—C(═O)—NH—] and at least one of groups [—O—C(═S)—NH—] and [—S—C(═O)—NH—]. The organic compound (Ab) is preferably either a compound having a silanol group in the molecule or a compound which forms a silanol group by hydrolysis.

### 1) Polymerizable Unsaturated Group

There are no specific limitations to the polymerizable unsaturated group included in the organic compound (Ab). An acryloyl group, methacryloyl group, vinyl group, propenyl group, butadienyl group, styryl group, ethynyl group, cinnamoyl group, maleate group, and acrylamide group can be given as suitable examples. The polymerizable unsaturated group is a structural unit which undergoes addition polymerization by active radical species.

### 2) Group Shown by Formula (1)

The group [—U—C(═V)—NH—] shown by the formula (1) included in the specific organic compound is [—O—C(═O)—NH—], [—O—C(═S)—NH—], [—S—C(═O)—NH—], [—NH—C(═O)—NH—], [—NH—C(═S)—NH—], or [—S—C(═S)—NH—]. These groups may be used either individually or in combination of two or more. Of these, combined use of the group [—O—C(═O)—NH—] and at least either the group [—O—C(═S)—NH—] or [—S—C(═O)—NH—] is preferable from the viewpoint of heat stability.

The group [—U—C(═V)—NH—] shown by the formula (1) is considered to cause a moderate cohesive force to occur between the molecules due to hydrogen bonds, and provide the resulting cured product with excellent mechanical strength, adhesion to a substrate, heat resistance, and the like.

### 3) Silanol Group or Group Which Forms Silanol Group by Hydrolysis

The organic compound (Ab) is preferably either a compound having a silanol group (hereinafter may be called “silanol group-containing compound”) or a compound which forms a silanol group by hydrolysis (hereinafter may be called “silanol group-forming compound”). As the silanol group-forming compound, a compound in which an alkoxy group, aryloxy group, acetoxy group, amino group, a halogen atom, or the like is bonded to a silicon atom can be given. Of these, a compound in which an alkoxy group or an aryloxy group is bonded to a silicon atom, specifically, a compound containing an alkoxysilyl group or a compound containing an aryloxysilyl group is preferable.

The silanol group or the silanol group-forming site of the silanol group-forming compound is a structural unit which bonds to the oxide particle (Aa) by condensation or condensation occurring after hydrolysis.

### 4) Preferred Embodiment

As a preferable example of the organic compound (Ab), a compound shown by the following formula (2) can be given. 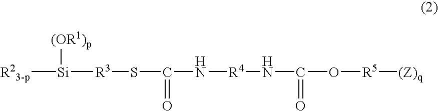
wherein R¹ and R² individually represent a hydrogen atom, an alkyl group or aryl group having 1-8 carbon atoms, such as a methyl group, ethyl group, propyl group, butyl group, octyl group, phenyl group, or xylyl group, and p is an integer from 1 to 3.

As examples of the group [(R¹O)ₚR²₃₋ₚSi—], a trimethoxysilyl group, triethoxysilyl group, triphenoxysilyl group, methyldimethoxysilyl group, dimethylmethoxysilyl group, and the like can be given. Of these, a trimethoxysilyl group or a triethoxysilyl group is preferable.

R³ is a divalent organic group having a C₁-C₁₂ aliphatic or aromatic structure, and may include a linear, branched, or cyclic structure.

R⁴ is a divalent organic group and is generally selected from divalent organic groups having a molecular weight of 14-10,000, and preferably 76-500.

R⁵ is an organic group with a valence of (q+1) and is preferably selected from linear, branched, and cyclic saturated and unsaturated hydrocarbon groups.

Z is a monovalent organic group having a polymerizable unsaturated group in the molecule which undergoes an intermolecular crosslinking reaction in the presence of active radicals. q is preferably an integer from 1 to 20, more preferably from 1 to 10, and particularly preferably from 1 to 5.

The organic compound (Ab) used in the present invention may be synthesized by using the method described in Japanese Patent Application Laid-open No. 9-100111, for example.

The amount of the organic compound (Ab) bonded to the oxide particles (Aa) is preferably 0.01 wt % or more, more preferably 0.1 wt % or more, and particularly preferably 1 wt % or more of 100 wt % of the reactive particles (A) (oxide particles (Aa) and organic compound (Ab) in total). If the amount of the organic compound (Ab) bonded to the oxide particles (Aa) is less than 0.01 wt %, dispersibility of the reactive particles (A) in the composition may be insufficient, whereby transparency and scratch resistance of the resulting cured product may be insufficient. The amount of the oxide particles (Aa) in the raw materials when preparing the reactive particles (A) is preferably 5-99 wt %, and still more preferably 10-98 wt %.

The amount (content) of the reactive particles (A) in the curable composition is preferably 5-90 wt %, and still more preferably 15-85 wt % of 100 wt % of the composition (reactive particles (A), compound (B), and compound (C) in total). If the amount is less than 5 wt %, a product with a high refractive index may not be obtained. If the amount is more than 90 wt %, film formability may be insufficient.

In this case, the content of the oxide particles (Aa) which make up the reactive particles (A) in the composition is preferably 65-90 wt %.

The amount of the reactive particles (A) refers to the solid content. In the case where the reactive particles (A) are used in the form of solvent dispersed sol, the amount of the reactive particles (A) does not include the amount of the solvent.

2. Compound (B)

The compound (B) used in the present invention is a melamine compound having no polymerizable unsaturated group. The compound (B) is preferably a compound shown by the formula (3).

The compound (B) is suitably used to increase the refractive index of the resulting cured product and improve chemical resistance of the laminate. 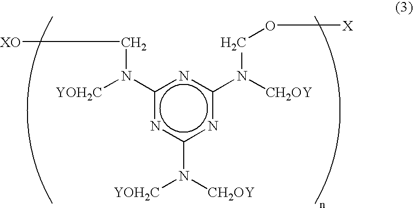
wherein X individually represents a hydrogen atom or an alkyl group having 1-10 carbon atoms, Y individually represents a hydrogen atom, an alkyl group having 1-10 carbon atoms, or a monovalent organic group shown by the following formula (4), and n is an integer from 1 to 20. 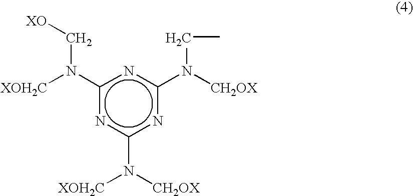
wherein X individually represents a hydrogen atom or an alkyl group having 1-10 carbon atoms.

As examples of alkyl groups having 1-10 carbon atoms represented by X and Y in the formulas (3) and (4), linear or branched alkyl groups such as a methyl group, ethyl group, n-propyl group, and isopropyl group can be given. Of these, lower alkyl groups having 1-5 carbon atoms are preferable.

As X in the formulas (3) and (4), a methyl group, isobutyl group, sec-butyl group, and tert-butyl group are preferable.

X in the formula (3) is preferably a methyl group since excellent curability is obtained.

As Y in the formula (3), a methyl group, isobutyl group, sec-butyl group, tert-butyl group, and organic group shown by the formula (4) are preferable.

As commercially available products of the compound (B), Cymel 238, XV805, XM2819, Cymel 303 (manufactured by Mitsui-Cytec, Ltd.), Nikalac E-1201 (manufactured by Sanwa Chemical Co., Ltd.), and the like can be given.

The number average molecular weight of the compound (B) used in the present invention is preferably from 300 to 20,000. The number average molecular weight of the compound (B) is still more preferably 300 to 5,000. If the number average molecular weight is less than 500, chemical resistance of the resulting laminate may be insufficient. If the number average molecular weight exceeds 20,000, applicability may be insufficient.

The compound (B) may be used in combination of two or more. In the case where the compound (B) is the compound shown by the formula (3), two or more compounds in which X, Y, or n differs may be used in combination.

In particular, at least 25 mol % of X and Y which is a hydrogen atom or an alkyl group in the melamine compound having no polymerizable unsaturated group of the component (B) is preferably an isobutyl group. If the content of the isobutyl group is 25 mol % or more, scratch resistance is increased. More preferably, an isobutyl group accounts for 40 mol % or more.

The amount of the compound (B) used in the present invention is preferably 0.01-50 wt %, and still more preferably 1-40 wt % of 100 wt % of the composition (reactive particles (A), compound (B), and compound (C) in total). If the amount is less than 0.01 wt %, chemical resistance of the laminate may be insufficient. If the amount exceeds 50 wt %, hardness of the cured product may be insufficient.

3. Compound (C)

The compound (C) used in the present invention is a compound having a polymerizable unsaturated group and having a hydroxyl value of 110 mgKOH/g or more. The compound (C) is suitably used to increase film formability of the composition and to improve scratch resistance of the cured product of the composition of the present invention. As examples of the compound (C), a hydroxyl group-containing melamine acrylate, a hydroxyl group-containing (meth)acrylate, and a hydroxyl group-containing vinyl compound can be given. It is preferable to use a hydroxyl group-containing (meth)acrylate from the viewpoint of improvement of scratch resistance. It is still more preferable to use a hydroxyl group-containing (meth)acrylate having a hydroxyl value of 110 mgKOH/g or more, and particularly preferably 150 mgKOH/g or more.

Specific examples of the compound (C) used in the present invention are given below.

As examples of the hydroxyl group-containing (meth)acrylate, a hydroxyl group-containing monofunctional (meth)acrylate and a hydroxyl group-containing polyfunctional (meth)acrylate can be given. As specific examples of the hydroxyl group-containing monofunctional (meth)acrylate, a hydroxyalkyl(meth)acrylate having 2-12 carbon atoms such as hydroxyethyl(meth)acrylate, ethylene glycol mono(meth)acrylate, neopentyl glycol mono(meth)acrylate, diethylene glycol mono(meth)acrylate, triethylene glycol mono(meth)acrylate, dipropylene glycol mono(meth)acrylate, bis(2-hydroxyethyl)isocyanurate mono(meth)acrylate, mono(meth)acrylate in which (poly)ethylene oxide or (poly)propylene oxide having 2-10 carbon atoms is added to the starting alcohol of the above mono(meth)acrylate, and mono(meth)acrylate in which (poly)ethylene oxide or (poly)propylene oxide having 2-10 carbon atoms is added per site of the amide bond of isocyanuric acid can be given.

As examples of the polyfunctional (meth)acrylate, pentaerythritol tri(meth)acrylate, tri(meth)acrylate of a monoethylene oxide or monopropylene oxide addition product of pentaerythritol, pentaerythritol di(meth)acrylate, dipentaerythritol tetra(meth)acrylate, dipentaerythritol tri(meth)acrylate, dipentaerythritol di(meth)acrylate, glycerol di(meth)acrylate, poly(meth)acrylate in which (poly)ethylene oxide or (poly)propylene oxide having 2-8 carbon atoms is added per hydroxyl group of the starting alcohol of the above (meth)acrylate, di(meth)acrylate in which (poly)ethylene oxide or (poly)propylene oxide having 2-4 carbon atoms is added per site of the amide bond of isocyanuric acid, oligo epoxy(meth)acrylate, and the like can be given.

Of these hydroxyl group-containing (meth)acrylates, monofunctional and polyfunctional (meth)acrylates having a hydroxyl value of 110 mgKOH/g or more, such as pentaerythritol tri(meth)acrylate, are preferable from the viewpoint of scratch resistance.

As examples of commercially available products of the hydroxyl group-containing (meth)acrylate, Aronix M-400, M-305, M-215 (manufactured by Toagosei Co., Ltd.), PET-30 (mixture of pentaerythritol triacylate as the component (C) and pentaerythritol tetraacrylate as the component (F) at a weight ratio of 60 to 40; manufactured by Nippon Kayaku Co., Ltd.), Light Acrylate PE-3A, Epoxy ester M-600A, 40EM, 70PA, 200PA, 1600A, 80MFA, 3002M, 3002A, 3000M, 3000A, 200EA, 400EA (manufactured by Kyoeisha Chemical Co., Ltd.), and the like can be given.

As examples of the hydroxyl group-containing vinyl compound, a hydroxyl group-containing vinyl ether such as 2-hydroxyethyl vinyl ether, 3-hydroxypropyl vinyl ether, 2-hydroxy propyl vinyl ether, 4-hydroxybutyl vinyl ether, 3-hydroxybutyl vinyl ether, 5-hydroxypentyl vinyl ether, 6-hydroxyhexyl vinyl ether, and diethylene glycol monovinyl ether, a hydroxyl group-containing allyl ether such as 2-hydroxyethyl allyl ether, 4-hydroxybutyl allyl ether, and glycerol monoallyl ether, allyl alcohol, and the like can be given. As commercially available products of the hydroxyl group-containing vinyl compound, HEVE, HBVE (manufactured by Nippon Carbide Industries Co., Inc.), HEVE, HBVE, DEGV (manufactured by Maruzen Petrochemical Co., Ltd.), and the like can be given.

The amount (content) of the compound (C) used in the present invention is preferably 10-80 wt %, and still more preferably 10-50 wt % of 100 wt % of the composition (reactive particles (A), compound (B), and compound (C) in total). If the amount is less than 5 wt % or exceeds 80 wt %, the resulting cured product may not have sufficient hardness.

A compound having a polymerizable unsaturated group in the molecule may optionally be included in the composition of the present invention in addition to the compound (C).

4. Acid Generator

In addition to the reactive particles (A), compound (B), and compound (C), (D) an acid generator (hereinafter may be referred to as “acid generator (D)”) may be added to the composition of the present invention, as required.

As examples of the acid generator (D), a compound which thermally generates cation species and a compound which generates cation species upon irradiation with radiation (light) known in the art can be given.

As examples of the compound which thermally generates cation species, an aliphatic sulfonic acid, aliphatic sulfonate, aliphatic carboxylic acid, aliphatic carboxylate, aromatic carboxylic acid, aromatic carboxylate, alkylbenzene sulfonic acid, alkylbenzene sulfonate, phosphate, metal salt, and the like can be given.

These onium salts may be used either individually or in combination of two or more.

As a preferable example of a compound which generates cation species upon irradiation, an onium salt having a structure shown by the following formula (5) can be given.

The onium salt generates a Lewis acid upon exposure to light.
[R⁶ₐR⁷_{b}R⁸_{c}R⁹_{d}W^{]+e}[ML_{e+f}]^{-e} (5)
wherein a cation is an onium ion; W is S, Se, Te, P, As, Sb, Bi, O, I, Br, Cl, or N≡N—; R⁶, R⁷, R⁸, and R⁹ are the same or different organic groups; a, b, c, and d are individually integers from 0 to 3, provided that (a+b+c+d) is equal to the valence of W; M is a metal or a metalloid which constitutes a center atom of the halide complex [ML_{e+f}] such as B, P, As, Sb, Fe, Sn, Bi, Al, Ca, In, Ti, Zn, Sc, V, Cr, Mn, and Co; L is a halogen atom such as F, Cl, and Br; e is a positive charge of a halide complex ion; and f is a valence of M.

As specific examples of the anion [ML_{e+f}] in the formula (5), tetrafluoroborate (BF₄⁻), hexafluorophosphate (PF₆⁻), hexafluoroantimonate (SbF₆⁻), hexafluoroarsenate (AsF₆⁻), hexachloroantimonate (SbCl₆⁻), and the like can be given.

An onium salt having an anion of the formula [ML_{f}(OH)] may also be used. Onium salts having other anions such as a perchloric acid ion (ClO₁₄), trifluoromethanesulfonic acid ion (CF₃SO₃⁻), fluorosulfonic acid ion (FSO₃⁻), toluenesulfonic acid ion, trinitrobenzenesulfonic acid anion, and trinitrotoluenesulfonic acid anion may be used.

Of these onium salts, aromatic onium salts are particularly effective as the acid generator (D). Among the aromatic onium salts, aromatic halonium salts disclosed in Japanese Patent Applications Laid-open No. 50-151996 and No. 50-158680, VIA group aromatic onium salts disclosed in Japanese Patent Applications Laid-open No. 50-151997, No. 52-30899, No. 56-55420, and No. 55-125105; VA group aromatic onium salts disclosed in Japanese Patent Application Laid-open No. 50-158698; oxosulfoxonium salts disclosed in Japanese Patent Applications Laid-open No. 56-8428, No. 56-149402, and No. 57-192429; aromatic diazonium salts disclosed in Japanese Patent Application Laid-open No.49-17040; thiopyrylium salts disclosed in U.S. Pat. No. 4,139,655; and the like are preferable. In addition, iron/allene complex initiators, aluminum complex/photolysis silicon compound initiators, and the like may also be used.

These onium salts may be used either individually or in combination of two or more.

As examples of commercially available products of polymerization initiator suitably used as the acid generator (D), Catalyst 4050, 4040 (manufactured by Mitsui-Cytec, Ltd.), UVI-6950, UVI-6970, UVI-6974, UVI-6990 (manufactured by Union Carbide), Adekaoptomer SP-150, SP-151, SP-170, SP-171 (manufactured by Asahi Denka Co., Ltd.), Irgacure 261 (manufactured by Ciba Specialty Chemicals Inc.), Cl-2481, Cl-2624, Cl-2639, Cl-2064 (manufactured by Nippon Soda Co., Ltd.), CD-1010, CD-1011, CD-1012 (manufactured by Sartomer Company Inc.), DTS-102, DTS-103, NAT-103, NDS-103, TPS-103, MDS-103, MPI-103, BBI-103 (manufactured by Midori Kagaku Co., Ltd.), PCI-061T, PCI-062T, PCI-020T, PCI-022T (manufactured by Nippon Kayaku Co., Ltd.), and the like can be given. Of these, Catalyst 4050 (manufactured by Mitsui Cytec, Ltd.), UVI-6970, UVI-6974, UVI-6990, Adekaoptomer SP-150, SP-170, SP-171, CD-1012, and MPI-103 are preferable, because the resulting curable composition is provided with excellent surface curability.

The amount of the acid generator (D), which is optionally used in the present invention, is preferably 0.01-20 parts by weight, and still more preferably 0.1-10 parts by weight for 100 parts by weight of the composition (reactive particles (A), compound (B), and compound (C) in total). If the amount is less than 0.01 part by weight, film formability may be insufficient. If the amount exceeds 20 parts by weight, a cured product with high hardness may not be obtained.

5. Radical Polymerization Initiator (E)

In addition to the reactive particles (A), compound (B), compound (C), and acid generator (D), (E) a radical polymerization initiator (hereinafter may be referred to as “radical polymerization initiator (E)”) may be added to the composition of the present invention, as required.

As examples of the radical polymerization initiator (E), a compound which thermally generates active radicals (heat polymerization initiator) and a compound which generates active radicals upon irradiation with radiation (light) (radiation (photo) polymerization initiator) known in the art can be given.

There are no specific limitations to the radiation (photo) polymerization initiator insofar as such an initiator decomposes upon irradiation and generates radicals to initiate polymerization. Examples of such an initiator include acetophenone, acetophenone benzyl ketal, 1-hydroxycyclohexyl phenyl ketone, 2,2-dimethoxy-1,2-diphenylethan-1-one, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, benzoin propyl ether, benzoin ethyl ether, benzyl dimethyl ketal, 1-(4-isopropylphenyl)-2-hydroxy-2-methylpropan-1-one, 2-hydroxy-2-methyl-1-phenylpropan-1-one, thioxanethone, diethylthioxanthone, 2-isopropylthioxanthone, 2-chlorothioxanthone, 2-methyl-1-[4-(methylthio)phenyl]-2-morpholino-propan-1-one, 2-benzyl-2-dimethylamino-1-(4-morpholinophenyl)-butanone-1,4-(2-hydroxyethoxy)phenyl-(2-hydroxy-2-propyl)ketone, 2,4,6-trimethylbenzoyl diphenylphosphine oxide, bis-(2,6-dimethoxybenzoyl)-2,4,4-trimethylpentylphosphine oxide, and oligo(2-hydroxy-2-methyl-1-(4-(1-methylvinyl)phenyl)propanone).

As examples of commercially available products of the radiation (photo) polymerization initiator, Irgacure 184, 369, 651, 500, 819, 907, 784, 2959, CGI1700, CGI1750, CGI1850, CG24-61, Darocur 1116, 1173 (manufactured by Ciba Specialty Chemicals Inc.), Lucirin TPO (manufactured by BASF), Ebecryl P36 (manufactured by UCB), Esacure KIP150, KIP65LT, KIP100F, KT37, KT55, KTO46, KIP75/B (manufactured by Lamberti), and the like can be given.

The amount of the radical polymerization initiator (E) optionally used in the present invention is preferably 0.01-20 parts by weight, and still more preferably 0.1-10 parts by weight for 100 parts by weight of the composition (reactive particles (A), compound (B), and compound (C) in total). If the amount is less than 0.01 part by weight, hardness of the cured product may be insufficient. If the amount exceeds 20 parts by weight, the inside (inner layer) of the cured product may remain uncured.

The composition of the present invention may be cured using the photo polymerization initiator and the heat polymerization initiator in combination, as required.

As preferable examples of the heat polymerization initiator, peroxides, azo compounds, and like can be given. Specific examples include benzoyl peroxide, t-butyl-peroxybenzoate, azobisisobutyronitrile, and the like.

6. Compound (F) Having Polymerizable Unsaturated Group Other than Component (C)

The compound having a polymerizable unsaturated group other than the component (C) (component (F)) is a compound which has a polymerizable unsaturated group and does not have a hydroxyl group or has a hydroxyl value of less than 110 mgKOH/g. A compound having two or more polymerizable unsaturated groups in the molecule is preferable as the component (F). Film formability of the composition can be increased by adding the component (F). As examples of the component (F), a melamine acrylate, (meth)acrylate, or vinyl compound which does not have a hydroxyl group or has a hydroxyl value of less than 110 mgKOH/g can be given. As specific examples of the component (F), pentaerythritol tetraacrylate, dipentaerythritol pentacrylate, dipentaerythritol hexacrylate, and the like can be given.

As commercially available products of the component (F), KAYARAD DPHA (mixture of dipentaerythritol pentacrylate and dipentaerythritol hexacrylate at a weight ratio of 40 to 60; manufactured by Nippon Kayaku Co., Ltd.) and the like can be given.

7. Other Component

The curable composition of the present invention may include additives such as a photosensitizer, polymerization inhibitor, polymerization adjuvant, leveling agent, wettability improver, surfactant, plasticizer, UV absorber, antioxidant, antistatic agent, inorganic filler, pigment, dye, and the like insofar as the effects of the present invention are not impaired.

8. Application (Coating) Method of Composition

The composition of the present invention is suitable as an antireflection film or a coat material. As examples of substrates to which the composition is applied, plastic (polycarbonate, polymethacrylate, polystyrene, polyester, polyolefin, epoxy resin, melamine resin, triacetyl cellulose resin, ABS resin, AS resin, norbornene resin, and the like), metals, wood, paper, glass, slates, and the like can be given. The substrate may be in the shape of a plate, a film, or a three-dimensional formed product. As the coating method, a conventional coating method such as dipping, spray coating, flow coating, shower coating, roll coating, spin coating, brush coating, or the like can be given. The thickness of the film after drying and curing is 0.1-400 □m, and preferably 1-200 μm.

In order to adjust the film thickness, the composition of the present invention may be used after diluting the composition with a solvent. In the case where the composition is used as an antireflection film or a coat material, the viscosity of the composition is usually 0.1-50,000 mPa.s/25° C., and preferably 0.5-10,000 mPa.s/25° C.

9. Curing Method of Composition

The composition of the present invention is cured by applying heat and/or radiation (light). In the case of curing the composition by applying heat, an electric heater, infrared lamp, hot blast, and the like may be used as the heat source. In the case of curing the composition by applying radiation (light), there are no specific limitations to the radiation source insofar as the composition can be cured in a short period of time after application. As examples of the source of infrared rays, a lamp, resistance heating plate, laser, and the like can be given. As examples of the source of visible rays, sunlight, a lamp, fluorescent lamp, laser, and the like can be given. As examples of the source of ultraviolet rays, a mercury lamp, halide lamp, laser, and the like can be given. As examples of the source of electron beams, a system utilizing thermoelectrons generated from a commercially available tungsten filament, a cold cathode method which generates electron beams by applying a high voltage pulse through a metal, and a secondary electron method which utilizes secondary electrons generated by collision between ionized gaseous molecules and a metal electrode can be given. As examples of the source of α-rays, β-rays, and γ-rays, fissionable substances such as Co⁶⁰ and the like can be given. As the source of γ-rays, a vacuum tube which causes accelerated electrons to collide with an anode or the like may be utilized. The radiation can be used either individually or in combination of two or more. In the latter case, two or more types of radiation may be applied either simultaneously or at a specific interval of time.

The curing reaction of the composition of the present invention can be performed in air or under anaerobic conditions such as nitrogen. The cured product of the composition exhibits excellent scratch resistance even in the case where the composition is cured under anaerobic conditions.

II. Cured Product

The cured product of the present invention may be obtained by applying the curable composition to various types of substrates such as a plastic substrate and curing the composition. Specifically, such a cured product can be obtained as a coated form by applying the composition onto an object, drying the coating by removing volatile components at a temperature preferably from 0 to 200° C., and curing the coating by heat and/or radioactive rays. In the case of curing the composition by applying heat, the composition is preferably cured at 20-150° C. for 10 seconds to 24 hours. In the case of curing the composition by applying radiation, use of ultraviolet rays or electron beams is preferable. In this case, the dose of ultraviolet rays is preferably 0.01-10 J/cm², and still more preferably 0.1-2 J/cm². Irradiation conditions for electron beams are preferably at an accelerated voltage of 10-300 KV, an electron density of 0.02-0.30 mA/cm², and a dose of 1-10 Mrad.

Since the cured product of the present invention has high hardness and high refractive index and is capable of forming a coat (film) excelling in scratch resistance and adhesion to a substrate and a low-refractive-index layer, the cured product is particularly suitable as an antireflection film for film-type liquid crystal elements, touch panels, plastic optical parts, and the like.

III. Laminate

The laminate of the present invention is formed by layering a high-refractive-index cured film obtained by curing the curable composition and a low-refractive-index film on a substrate in that order. The laminate is particularly suitable as an antireflection film.

There are no specific limitations to the substrate used in the present invention. In the case of using the laminate as an antireflection film, substrates made of plastic (polycarbonate, polymethylmethacrylate, polystyrene, polyester, polyolefin, epoxy resin, melamine resin, triacetyl cellulose resin, ABS resin, AS resin, norbornene resin, and the like) can be given.

As examples of the low-refractive-index film used in the present invention, a metal oxide film made of magnesium fluoride or silicon dioxide, a fluorine-type coat material cured film, and the like having a refractive index of 1.38-1.45 can be given.

Another film may be present between the high-refractive-index cured film and the low-refractive-index film or between the substrate and the high-refractive-index cured film. For example, a hard coat layer or an antireflection layer may be provided between the substrate and the high-refractive-index cured film.

As a method for forming the low-refractive-index film on the high-refractive-index cured film obtained by curing the curable composition, in the case of forming a metal oxide film, vacuum deposition, sputtering, and the like can be given. In the case of forming a fluorine-type coat material cured film, a method the same as the application (coating) method of the composition can be given.

Reflection of light on the surface of the substrate can be effectively prevented by layering the high-refractive-index cured film and the low-refractive-index film on the substrate.

The laminate of the present invention is particularly suitable as an antireflection film for film-type liquid crystal elements, touch panels, plastic optical parts, and the like, since the laminate has a low reflectance and excels in chemical resistance.

### EXAMPLES

The present invention is described below in detail by examples, which should not be construed as limiting the present invention. In the examples, “part(s)” refers to “part(s) by weight” and “%” refers to “wt %” unless otherwise indicated.

Curable Composition

### Preparation Example 1

Preparation of oxide particles (Aa) 300 parts of fine spherical zirconia particles (manufactured by Sumitomo Osaka Cement Co., Ltd., number average primary particle diameter: 0.01 μm) were added to 700 parts of methyl ethyl ketone (MEK) and dispersed for 168 hours using glass beads. The glass beads were then removed to obtain 950 parts of methyl ethyl ketone zirconia sol (Aa). 2 g of the dispersion sol was weighed in an aluminum dish and dried at 120° C. for one hour on a hot plate. The dried product was weighed to indicate that the solid content was 30%. As a result of electron microscope observation of the solid product, the minor axis average particle diameter was 15 nm, the major axis average particle diameter was 20 nm, and the aspect ratio was 1.3.

### Preparation Example 2

Preparation of organic compound (Ab) having polymerizable unsaturated group 20.6 parts of isophorone diisocyanate were added dropwise to 7.8 parts of mercaptopropyltrimethoxysilane and 0.2 part of dibutyltin dilaurate in a vessel equipped with a stirrer at 50° C. for one hour in dry air. The mixture was stirred at 60° C. for three hours.

After the addition of 71.4 parts of pentaerythritol triacrylate dropwise at 30° C. for one hour, the mixture was stirred at 60° C. for three hours to obtain a reaction solution.

The residual isocyanate content in the reaction product (organic compound having a polymerizable unsaturated group) in the reaction solution was analyzed by FT-IR and found to be 0.1 wt % or less. This indicates that each reaction was completed almost quantitatively. The organic compound had a thiourethane bond, urethane bond, alkoxysilyl group, and acryloyl group (polymerizable unsaturated group) in the molecule.

### Preparation Example 3

### Preparation of Fine Reactive zirconia Powder sol (A-1)

A mixture of 5.2 parts of the organic compound (Ab) having a polymerizable unsaturated group prepared in Preparation Example 2, 237 parts of methyl ethyl ketone zirconia sol (Aa) (zirconia content: 30%) prepared in Preparation Example 1, 0.1 part of ion-exchanged water, and 0.03 part of p-hydroxyphenyl monomethyl ether was stirred at 60° C. for three hours. After the addition of 1.0 part of methyl orthoformate, the mixture was stirred for one hour at the same temperature to obtain reactive particles (dispersion liquid (A-1)). 2 g of the dispersion liquid (A-1) was weighed in an aluminum dish and dried on a hot plate at 120° C. for one hour. The dried product was weighed to confirm that the solid content was 31%. 2 g of the dispersion liquid (A-1) was weighed in a magnetic crucible, predried on a hot plate at 80° C. for 30 minutes, and sintered at 750° C. for one hour in a muffle furnace. The inorganic content in the solid content was determined from the resulting inorganic residue to confirm that the inorganic content was 93%.

### Preparation Example 4

### Preparation of Fine Reactive silica powder sol (A-2)

A mixture of 8.7 parts of the organic compound (Ab) having a polymerizable unsaturated group prepared in Preparation Example 2, 91.3 parts of silica particle sol (methyl ethyl ketone silica sol, “MEK-ST” manufactured by Nissan Chemical Industries, Ltd., number average particle diameter: 0.022 μm, silica content: 30%) (27 parts as silica particles), and 0.1 part of ion-exchanged water was stirred at 60° C. for three hours. After the addition of 1.4 parts of methyl orthoformate, the mixture was stirred at 60° C. for one hour to obtain reactive particles (dispersion liquid (A-2)). 2 g of the dispersion liquid (A-2) was weighed in an aluminum dish and dried on a hot plate at 175° C. for one hour. The dried product was weighed to confirm that the solid content was 35%.

### Example 1

164.6 parts of the fine reactive zirconia powder sol (A-1) prepared in the Preparation Example 3 (reactive zirconia: 51.0 parts), 35.8 parts of a mixture of pentaerythritol triacylate and pentaerythritol tetraacrylate (C-1 and F-3) (“KAYARAD PET-30” manufactured by Nippon Kayaku Co., Ltd.), 113.6 parts of methyl isobutyl ketone (hereinafter abbreviated as MIBK) were mixed in a UV shielding vessel. The mixture was condensed using a rotary evaporator until the solid content was 65.5%. After the addition of 6.2 parts of a melamine compound (B-1) (“Cymel 238” manufactured by Mitsui-Cytec, Ltd., mixed alkylated melamine; in the formula (3), n=1.8 on average, 40 mol % of X and Y which is hydrogen or an alkyl group is an isobutyl group, with the remaining 60 mol % being a methyl group), 4.0 parts of Catalyst 4050 (D-1) (manufactured by Mitsui-Cytec, Ltd., isopropyl alcohol solution, solid content: 55 wt %), 1.9 parts of 1-hydroxycyclohexyl phenyl ketone (E-1), 1.1 part of 2-methyl-1-[4-(methylthio)phenyl]-2-morpholinopropane-1 (E-2), and 51.2 parts of MIBK to the condensed product, the mixture was stirred at 30° C. for two hours to obtain a homogeneous composition solution. The solid content of the composition measured in the same manner as in the Preparation Example 3 was 50%.

### Examples 2-10 and Comparative Examples 1-5

A composition was obtained in the same manner as in Example 1 except for changing the composition as shown in Table 1. The compositions in Examples 1 and 10 and Comparative Examples 1 and 5 are the same compositions except for the curing conditions as described later.

Laminate

### Preparation Example 5

### Preparation of Curable Composition (Coating Liquid A) for Low-Refractive-Index Film

1) Preparation of Fluorine-Containing Polymer Having Hydroxyl Group The atmosphere in a stainless steel autoclave (1.5 1) equipped with an electromagnetic stirrer was sufficiently replaced with nitrogen gas. The autoclave was charged with 500 g of ethyl acetate, 34.0 g of ethyl vinyl ether (EVE), 41.6 g of hydroxyethyl vinyl ether (HEVE), 75.4 g of perfluoropropyl vinyl ether (FPVE), 1.3 g of lauroyl peroxide, 7.5 g of silicone-containing high polymer azo initiator (“VPS1001” manufactured by Wako Pure Chemical, Ltd.), and 1 g of a reactive emulsifying agent (“NE-30” Manufactured by Asahi Denka Co., Ltd.). After cooling the mixture to −50° C. with dry ice-methanol, oxygen contained in the system was removed by using nitrogen gas.

After the addition of 119.0 g of hexafluoropropylene (HFP), the temperature in the autoclave was increased. The pressure was 5.5×10⁵ Pa when the temperature in the autoclave reached 70° C. The reaction was allowed to proceed at 70° C. for 20 hours while stirring. When the pressure was decreased to 2.3×10⁵ Pa, the reaction was terminated by cooling the autoclave with water. After the temperature in the autoclave reached room temperature, unreacted monomers were removed. The autoclave was opened to obtain a polymer solution with a solid content of 30 wt %. The resulting polymer solution was poured into methanol to precipitate the polymer. The precipitate was washed with methanol and dried at 50° C. under vacuum to obtain 170 g of a fluorine-containing polymer having a hydroxyl group.

The intrinsic viscosity of the resulting fluorine-containing polymer having a hydroxyl group measured at 25° C. using an N,N-dimethylacetamide solvent was 0.28 dl/g.

The glass transition temperature of the fluorine-containing polymer determined using a differential scanning calorimeter (DSC) at a temperature increase rate of 5° C./min. in a nitrogen stream was 31° C.

The fluorine content of the fluorine-containing polymer determined by an alizarin complexone method was 51.7%.

The hydroxyl value of the fluorine-containing polymer determined by an acetylation method using acetic anhydride was 102 mgKOH/g.

2) Preparation of Curable Composition (Coating Liquid A) for Low-Refractive-Index film

A vessel equipped with a stirrer was charged with 100 g of the fluorine-containing copolymer having a hydroxyl group obtained in 1), 11.1 g of Cymel 303 (manufactured by Mitsui-Cytec, Ltd.), and 3,736 g of methyl isobutyl ketone (MIBK). The mixture was stirred at 110° C. for five hours to allow the fluorine-containing copolymer having a hydroxyl group to react with the Cymel 303.

After the addition of 11.1 g of Catalyst 4040 (manufactured by Mitsui-Cytec, Ltd., solid content: 40 wt %), the mixture was stirred for 10 minutes to obtain a curable composition for a low-refractive-index film having a viscosity of 1 mPa.s (measured at 25° C.) (hereinafter may be called “coating liquid A”).

The refractive index of a low-refractive-index film obtained from the resulting curable composition for a low-refractive-index film (coating liquid A) was measured.

The curable composition for a low-refractive-index film was applied to a silicon wafer (thickness: 1 μm) using a wire bar coater (#3) and air-dried at room temperature for five minutes to form a coat. The coat was cured by heating at 140° C. for one minute in an air dryer to obtain a low-refractive-index film with a thickness of 0.3 μm. The refractive index of the resulting low-refractive-index film at a Na-D line was measured at 25° C. using a spectroscopic ellipsometer. As a result, the refractive index was 1.40.

### Example 11

### Preparation of Antireflection Film Laminate

Each of the compositions obtained in Examples 1-10 of the present invention and Comparative Example 1-5 was applied to a polyester film (“A4300” manufactured by Toyobo Co., Ltd., thickness: 188 μm) using a wire bar coater (#6) and dried at 80° C. for one minute in an oven to form a coat. The coat was cured by irradiation of UV rays at a dose of 0.3 J/cm² using a metal halide lamp in nitrogen atmosphere (Examples 1-9 and Comparative Examples 1-4) or in air (Examples 10 and Comparative Examples 5) to obtain a high-refractive-index film with a thickness of 3 □m.

The coating liquid A was applied to the high-refractive-index film using a wire bar coater (#3) and air-dried at room temperature for five minutes to form a coat. The coat was cured by heating at 140° C. for one minute in an oven to form a low-refractive-index film with a thickness of 0.1 μm, to obtain an antireflection film laminate.

### Evaluation Example

### Evaluation of Antireflection Film Laminate

Scratch resistance, reflectance, turbidity (Haze value), total light transmittance, and chemical resistance of the antireflection film laminate obtained in Example 11 were measured or evaluated according to the methods given below.

1) Reflectance

The reflectance (minimum reflectance in measurement wavelength region) of the antireflection film laminate was measured at a wavelength of 340-700 nm using a spectrophotometric reflectance measurement system (spectrophotometer “U-3410” manufactured by Hitachi Ltd. equipped with large sample compartment integrating sphere “150-09090”) according to JIS K7105 (measurement method A). Specifically, the minimum reflectance of the antireflection film laminate (antireflection film) at each wavelength was measured while employing the reflectance of a deposited aluminum film as a standard (100%). The results are shown in Table 1.

2) Total Light Transmittance and Turbidity (Haze Value)

The total light transmittance and the Haze value of the antireflection film laminate were measured according to JIS K7105 using a color Haze meter (manufactured by Suga Test Instruments Co., Ltd.). The results are shown in Table 1.

3) Scratch Resistance

The surface of the antireflection film laminate was rubbed with #0000 steel wool 10 times at a load of 200 g/cm² to evaluate the scratch resistance of the antireflection film laminate by naked eye observation according to the following criteria. The results are shown in Table 1.
Grade 5: No scratch was observed.
Grade 4: 1-5 scratches were observed.
Grade 3: 6-50 scratches were observed.
Grade 2: 51-100 scratches were observed.
Grade 1: Peeling of film was observed.

A laminate with a scratch resistance of grade 2 or more is allowable in actual application. A laminate with a scratch resistance of grade 4 or more is preferable due to excellent durability in actual application. A laminate with a scratch resistance of grade 5 is still more preferable because durability in actual application is significantly improved.

4) Chemical Resistance

The resulting antireflection film laminate was immersed in a 1 N NaOH aqueous solution at 60° C. for one minute and washed with distilled water. The surface of the laminate was rubbed with #0000 steel wool 10 times at a load of 200 g/cm² to evaluate the chemical resistance of the antireflection film laminate by naked eye observation according to the following criteria. The results are shown in Table 1.
Grade 5: No scratch was observed.
Grade 4: 1-5 scratches were observed.
Grade 3: 6-50 scratches were observed.
Grade 2: 51-100 scratches were observed.
Grade 1: Peeling of film was observed.

A laminate with a chemical resistance of grade 2 or more is allowable in actual application. A laminate with a chemical resistance of grade 4 or more is preferable due to excellent durability in actual application. A laminate with a chemical resistance of grade 5 is still more preferable because durability in actual application is significantly improved.

TABLE 1

| | Example | | | | | | | | | | Comparative example | | | | |
|---|---|---|---|---|---|---|---|---|---|---|---|---|---|---|---|
| | 1 | 2 | 3 | 4 | 5 | 6 | 7 | 8 | 9 | 10 | 1 | 2 | 3 | 4 | 5 |
| Reactive particles (A) | | | | | | | | | | | | | | | |
| A-1 | 51.0 | 51.0 | 51.0 | 19.1 | 66.7 | 51.0 | 51.0 | 51.0 | | 51.0 | 51.0 | 51.0 | 51.0 | 49.3 | 51.0 |
| A-2 | | | | | | | | | 44.8 | | | | | | |
| Melamine compound (B) | | | | | | | | | | | | | | | |
| B-1 | 6.2 | 6.2 | 10.0 | 30.0 | 8.1 | 6.2 | 6.2 | 6.2 | 5.6 | 6.2 | 6.2 | | | | 6.2 |
| Hydroxyl group-containing | | | | | | | | | | | | | | | |
| (meth)acrylate (C) | | | | | | | | | | | | | | | |
| C-1 | 21.5 | 23.9 | 19.2 | 26.3 | 9.7 | 14.2 | 7.3 | | 25.1 | 21.5 | | | | | |
| C-2 | | | | | | | | 35.8 | | | | | | | |
| Acid generator (D) | | | | | | | | | | | | | | | |
| D-1 | 4.0 | — | 4.0 | 4.0 | 5.2 | 4.0 | 4.0 | 4.0 | 3.6 | 4.0 | 4.0 | | 10.2 | | 4.0 |
| Photoinitiator (E) | | | | | | | | | | | | | | | |
| E-1 | 1.9 | 1.9 | 1.9 | 1.9 | 2.4 | 1.9 | 1.9 | 1.9 | 2.6 | 1.9 | 1.9 | 1.9 | 1.9 | 2.9 | 1.9 |
| E-2 | 1.1 | 1.1 | 1.1 | 1.1 | 1.5 | 1.1 | 1.1 | 1.1 | 1.6 | 1.1 | 1.1 | 1.1 | 1.1 | 1.7 | 1.1 |
| Compound (F) having | | | | | | | | | | | | | | | |
| Polymerizable unsaturated group | | | | | | | | | | | | | | | |
| other than component (C) | | | | | | | | | | | | | | | |
| F-1 | | | | | | 7.3 | 14.2 | | | | 35.8 | 46.0 | 35.8 | 46.1 | 35.8 |
| F-2 | | | | | | 4.9 | 9.4 | | | | | | | | |
| F-3 | 14.3 | 15.9 | 12.8 | 17.6 | 6.4 | 9.4 | 4.9 | 0.0 | 16.7 | 14.3 | | | | | |
| Organic solvent | | | | | | | | | | | | | | | |
| MEK | 4.6 | 4.6 | 4.6 | 4.6 | 4.6 | 4.6 | 4.6 | 4.6 | 15.2 | 4.6 | 4.6 | 7.9 | 4.6 | 15.7 | 4.6 |
| MIBK | 92.1 | 92.1 | 92.1 | 92.1 | 92.1 | 92.1 | 92.1 | 92.1 | 81.7 | 92.1 | 92.1 | 92.1 | 87.1 | 84.3 | 92.1 |
| IPA | 3.3 | 3.3 | 3.3 | 3.3 | 3.3 | 3.3 | 3.3 | 3.3 | 3.1 | 3.3 | 3.3 | | 8.3 | | 3.3 |
| Total | 200.0 | 200.0 | 200.0 | 200.0 | 200.0 | 200.0 | 200.0 | 200.0 | 200.0 | 200.0 | 200.0 | 200.0 | 200.0 | 200.0 | 200.0 |
| Solid content (%) | 50.0 | 50.0 | 50.0 | 50.0 | 50.0 | 50.0 | 50.0 | 50.0 | 50.0 | 50.0 | 50.0 | 50.0 | 50.0 | 50.0 | 50.0 |
| Laminate | | | | | | | | | | | | | | | |
| Curing atmosphere | N₂ | N₂ | N₂ | N₂ | N₂ | N₂ | N₂ | N₂ | N₂ | Air | N₂ | N₂ | N₂ | N₂ | Air |
| Thickness of high-refractive- | 3 | 3 | 3 | 3 | 3 | 3 | 3 | 3 | 3 | 3 | 3 | 3 | 3 | 3 | 3 |
| index layer (μm) | | | | | | | | | | | | | | | |
| Reflectance (%) | 0.4 | 0.4 | 0.4 | 0.4 | 0.4 | 0.4 | 0.4 | 0.4 | 1.2 | 0.4 | 0.4 | 0.4 | 0.4 | 0.4 | 0.4 |
| Light transmittance (%) | 91 | 92 | 91 | 91 | 90 | 91 | 91 | 92 | 91 | 91 | 91 | 90 | 90 | 90 | 91 |
| Haze (%) | 1.4 | 1.4 | 1.3 | 1.5 | 1.3 | 1.3 | 1.4 | 1.3 | 1.3 | 1.4 | 1.4 | 1.3 | 1.4 | 1.3 | 1.4 |
| Scratch resistance | 4 | 3 | 4 | 4 | 3 | 4 | 3 | 4 | 3 | 4 | 2 | 1 | 1 | 1 | 4 |
| Chemical resistance | 4 | 3 | 4 | 4 | 3 | 4 | 3 | 4 | 3 | 2 | 2 | 1 | 1 | 1 | 1 |

In Table 1, the amount of the reactive particles (A) indicates the weight of dry fine powder included in each dispersion sol (excluding organic solvent). The meanings of the abbreviations shown in Table 1 are as follows.
A-1: Reactive zirconia sol prepared in Preparation Example 3
A-2: Reactive silica sol prepared in Preparation Example 4
B-1: Melamine compound (Cymel 238 manufactured by Mitsui-Cytec, Ltd.)
C-1: Pentaerythritol triacrylate
C-2: Isocyanuric acid ethylene oxide modified diacrylate (M-215 manufactured by Toagosei Co., Ltd.; diacrylate in which polyethylene oxide having six carbon atoms is added to three amide bond of isocyanuric acid)
D-1: Catalyst 4050 (manufactured by Mitsui-Cytec, Ltd.)
E-1: 1-Hydroxycyclohexyl phenyl ketone
E-2: 2-Methyl-1-[4-(methylthio)phenyl]-2-morpholinopropanone-1
F-1: Dipentaerythritol hexaacrylate
F-2: Dipentaerythritol pentacrylate
F-3: Pentaerythritol tetraacrylate
MEK: Methyl ethyl ketone
MIBK: Methyl isobutyl ketone
IPA: Isopropyl alcohol

### EFFECT OF THE INVENTION

As described above, the present invention can provide a curable composition having excellent applicability and capable of forming a coat (film) having high hardness and high refractive index, excelling in scratch resistance and adhesion to a substrate and a low-refractive-index layer, and excelling in scratch resistance even in the case where the cured product is allowed to stand in a high pH environment or the composition is cured under anaerobic conditions on the surface of various types of substrates, a cured product of the curable composition, and a laminate having low reflectance and excelling in chemical resistance.

1. A curable composition comprising:
(A) particles obtained by bonding oxide particles of at least one element selected from the group consisting of silicon, aluminum, zirconium, titanium, zinc, germanium, indium, tin, antimony, and cerium with an organic compound having a polymerizable unsaturated group,
(B) a melamine compound having no polymerizable unsaturated group, and
(C) a compound which has a polymerizable unsaturated group and has a hydroxyl value of 110 mgKOH/g or more.

2. The curable composition according to claim 1, wherein the organic compound in the particle of the component (A) includes a group of the following formula (1) in addition to the polymerizable unsaturated group: 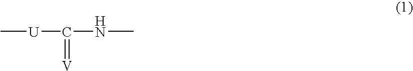
wherein U represents NH, O (oxygen atom), or S (sulfur atom), and V represents O or S.

3. The curable composition according to claim 1, wherein the compound (C) is a hydroxyl group-containing (meth)acrylate.

4. The curable composition according to claim 3, wherein the compound (C) includes pentaerythritol triacylate or isocyanuric acid diacrylate.

5. The curable composition according to claim 1, further comprising (D) an acid generator in addition to the components (A), (B), and (C).

6. A cured product obtained by curing the curable composition according to claim 1.

7. A process for producing a cured film comprising a step of curing the curable composition according to claim 1 under anaerobic conditions.

8. A laminate comprising a cured film obtained by curing the curable composition according to claim 1 and a low-refractive-index film which are layered on a substrate in that order.
